(19) United States
(12) Patent Application Publication
(10) Pub. No.: US 2002/0073388 A1
(43) Pub. Date: Jun. 13, 2002

(54) Methodology to improve the performance of integrated circuits by exploiting systematic process non-uniformity

(76) Inventors: Michael E. Orshansky, Oakland, CA (US); Linda Susan Milor, Berkeley, CA (US)

Correspondence Address: Linda Milor, 1730 Highland Place #1, Berkeley, CA, 94709, US

(21) Appl. No.: 09/733,411

(22) Filed: Dec. 11, 2000

Related U.S. Application Data
(60) Provisional application No. 60/169,492, filed on Dec. 7, 1999.

(51) Int. Cl. G06F 17/50

(52) U.S. Cl. 716/5; 716/4

(57) ABSTRACT

The present invention is a device to measure the deterministic structure of the variation of the gate critical dimension (CD), so that accurate topological information about CD variation within the optical field is obtained. The present invention also involves determining the most frequent gate configurations (orientation and neighboring features) in a layout of a specific circuit design, and including these most frequent gate configurations in the measurement device. The present invention further includes a method to determine CD maps across the optical field, based on the collection of CD data for specific gate configurations. The CD maps are used in the course of computer-aided design of IC's to improve the accuracy in which circuit performance metrics and yield are estimated. The present invention describes a set of methods in which the CD maps are integrated into the computer-aided design of ICs. In particular, the topological information, described by the CD maps, is used for accurate timing analysis, power dissipation analysis, yield prediction, floor planning, and placement of gates and blocks of large IC's within a chip.

### CROSS-REFERENCE TO RELATED APPLICATIONS

A provisional patent application was filed on Dec. 7, 1999 for this patent, with the application No. 60/169,492.

### BACKGROUND OF THE INVENTION

A. Technical Field

The present invention pertains to the computer-aided design (CAD) of integrated circuits (ICs). The invention is to be applied as a way to increase the performance (speed and power consumption) and yield of CMOS ICs. The gate critical dimension (CD) of MOS transistors, which influences the speed and power consumption of ICs, is subject to variability during the semiconductor manufacturing process. The present invention involves the collection of information about the gate CD variation, which is utilized in the course of computer-aided design of IC's to more accurately estimate circuit performance metrics and to improve the layout and floor planning of a circuit based on estimates of these metrics.

B. Background

Both speed and power consumption of an integrated circuit (IC) are its essential performance metrics. An IC is composed of transistors and other features. In CMOS IC's, speed and power consumption of ICs are strongly influenced by the amount of current (current drive) that is supplied by the transistors. Current drive of a MOS transistor strongly depends on the length of the transistor gate. Although an IC is composed of transistors, which are designed to have transistor gates of different lengths, for most ICs most of these transistors have gates where the length is the minimum manufacturable gate length so that the IC has maximum speed. This minimum manufacturable gate length is called the critical dimension (CD). Because most transistors in an IC are designed to have a minimum gate length, defined as the gate CD, control of the gate CD strongly influences the performance of the IC. For a set of transistors, designed to have the same CD, the smaller CDs give higher current drive, resulting in faster transistors, which, however, consume more power and may have lower yield (i.e., they are less frequently manufactured correctly). Hence, optimum performance for an IC involves selecting and accurately controlling the CD to achieve the required speed, power dissipation, and yield of high performance ICs.

A circuit is designed prior to being committed to manufacturing. During circuit design, computer-aided design tools are utilized to predict the circuit's performance metrics. If the predictions are not accurate, a circuit will need be re-designed, to better achieve the required performances. The gate CD is one of the inputs to the CAD tools that are used to estimate a circuit's performance. If the gate CD is accurately modeled, then the predicted performance metrics for a circuit are likely to be more accurate, which, in turn, increases the probability that the manufactured IC will satisfy performance requirements for the design.

The critical dimension (CD) of MOS transistors, however, is subject to variability during the semiconductor manufacturing process. There are many sources of variation, including variation between lots, wafers, across a wafer, and within the optical field (the area of the wafer that is printed with a single exposure of light). Referring to FIG. 1, a wafer 101 containing multiple optical fields 102 is illustrated. The present invention is concerned with CD variation within the optical field. It employs techniques to discover the underlying structure of the gate CD variation.

An optical field contains one or more circuits (ICs). The fact that the intra-field variability is largely deterministic means that at different locations within the optical field, within each IC contained in the optical field, and depending on the neighboring layout patterns, the CD value is different. Thus, spatially separated transistors with different local layout patterns, have distinct current drives and other important characteristics. By incorporating the accurate topological information about the CD variation within the optical field, it is possible to achieve greater performance and yield of circuits.

C. Previous State-of-the-Art Knowledge and the Present Invention

It has been known for a long time that the transistor CD is subject to variation resulting from the manufacturing process of semiconductors. Several ideas that are relevant for this invention have been previously overlooked.

First, for the purpose of computer-aided design, it has been assumed that the variability of the gate CD is negligible within the optical field. Recent experiments for advanced CMOS semiconductor manufacturing processes show that the intra (within) field variability is significant; the range of variation of CD in the field is large compared to the mean value of CD. This implies that the effect of this variation on circuit performance and yield is substantial.

Second, statistical decomposition analysis reveals that the within field variability is not random, as was previously believed, but deterministic (systematic). Thus, one can discover a deterministic (predictable) topological structure of gate CD variation within the optical field, and use it for circuit performance and yield enhancement. The deterministic topological structure of gate CD variation is a function of the specific manufacturing process and equipment used to fabricate the IC.

Third, a significant interaction between the global variability due to lens aberrations, and the local, pattern-dependent, variability has not been known or utilized. Accounting for this effect is necessary for achieving maximum accuracy in spatially-dependent circuit analysis.

### BRIEF SUMMARY OF THE INVENTION

One or more of the following steps of the standard CAD flow are modified so as to achieve superior performance of the resulting integrated circuit.

Prior to manufacturing a circuit, circuit analysis (simulation) is utilized to verify the functionality and estimate the performance of the circuit to be achieved after it is manufactured. Accurate circuit analysis is critical if the manufactured circuit is designed to meet certain requirements, relating to speed, power dissipation, and functionality. The present invention involves appending circuit simulators (such as SPICE), static timing analyzers (e.g. PathMill and Prime Time), and power analyzers (e.g. PowerMill) with the capability to model the device's and gate's characteristics (timing, power, etc.) depending on the location of the instance in the field and the neighboring layout patterns. It describes a sequence of steps allowing efficient integration of deterministic process variation into circuit analysis.

Information about the spatial variability of the device's characteristics is used at the floor planning stage of computer-aided design of ICs. Floor planning is the step where the physical location of various blocks within a circuit design is determined. The block locations are determined based on a cost function, in which criteria relating to area, power dissipation, and speed are optimized. The present invention involves modifying the cost function to include spatial information about the devices and gates. As a result, the blocks critical to circuit speed are placed in the chip regions that have the highest current drive. And, the circuit blocks whose power consumption is dominating overall chip power consumption are placed in the chip regions with larger CD values to reduce power consumption.

The advanced simulation and floor planning capabilities, outlined above, require, for their implementation, a modified technology library. The library contains information on the spatial CD variation across the optical field and its dependence on the gate's neighboring layout patterns. In an embodiment of the present invention, it also contains information about pre-designed blocks of a circuit, as a function of location within the optical field. The present invention involves the design and fabrication of test structures and measurements to determine the spatial CD variation across the optical field and the use of this data to determine models of pre-designed blocks of the circuits, as a function of location within the optical field. Because the deterministic structure of CD variation is hidden within substantial random noise, statistical methods are used to extract the deterministic trends and to generate the appropriate circuit models.

### BRIEF DESCRIPTION OF THE SEVERAL VIEWS OF THE DRAWING

FIG. 1 shows a top view of a wafer, containing several optical fields;

FIG. 2 displays an example description of the topological (spatial) map of CD (critical dimension) variation across the optical field;

FIG. 3 shows the top view of transistors with vertical and horizontal orientations, with respect to the flat of the wafer;

FIG. 4 shows the top view of six transistors, three with vertical and three with horizontal orientations, with different neighborhoods, so as to illustrate one embodiment of labeling gates according to their orientation and neighborhood;

FIG. 5 shows the top view of a resistor to be included in a test structure with four pads to be used to measure the resistance and calculate the gate CD;

FIG. 6 shows a representation of the test structure to be fabricated, including many copies of resistors and/or transistors repeated on a grid, throughout the optical field, for the purpose of measuring the gate CD throughout the optical field;

FIG. 7 shows the areas in the optical field corresponding to each discrete value of CD for a gate with a specific set of neighboring features; and

FIG. 8 shows the areas of the optical field associated with each model of a specific cell in the standard cell library hypothetically composed of transistors belonging to either of two categories, where each category corresponds to a specific set of neighboring features.

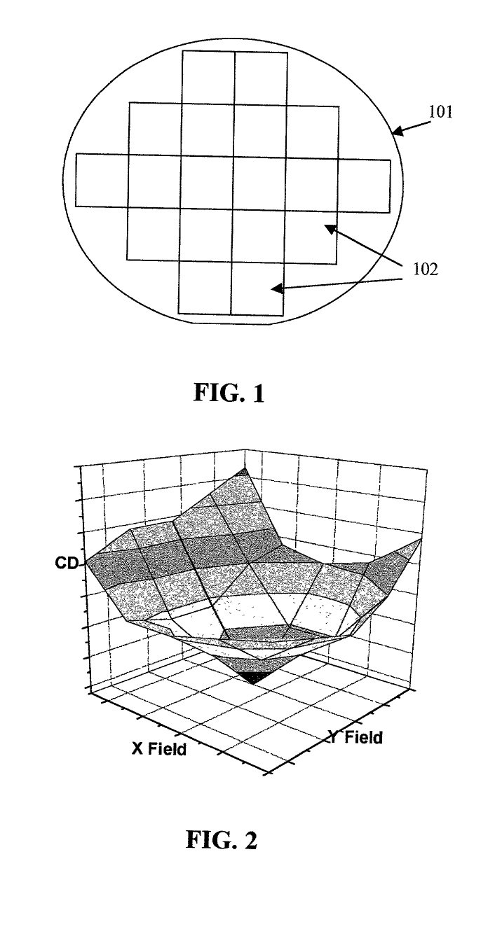

The figures referred to herein are drawn for clarity of illustration and are not necessarily drawn to scale. Moreover, although the figures contain some structures, other structures may be present in each embodiment; these structures have been omitted to enhance clarity of the illustrations. Elements having the same reference number refer to elements having a similar structure and function.

### DETAILED DESCRIPTION OF THE INVENTION

The present invention provides for a multi-step and multi-directional methodology to achieve superior performance and yield of integrated circuits, exploiting the fundamental variability of the gate critical dimension (CD).

A. Generation of the Technology Library

A fundamental part of the present invention is a procedure to generate an accurate representation of the systematic gate CD variation. Variation in the gate CD comes from global lens aberrations in the lithography system that is used to print the transistor gates (usually composed of polysilicon) on wafers. Variation in the gate CD is also caused by neighboring patterns, for example, the presence or absence of nearby gates, printed on the wafer at the same time. Moreover, the global lens aberrations interact with the local patterns in the neighborhood to produce spatial systematic CD variation which depends on the neighborhood of each gate (other nearby gates and features printed at the same time as the gates). FIG. 2 shows the gate CD variation for a gate with a specific set of neighboring features. The variation is represented as a spatial CD map (a topological surface, describing the variation of the gate CD over the optical field).

The spatial CD maps depend on the neighboring features of a specific transistor gate. A gate is most strongly influenced by features that are nearby. Hence the classification of gates according to their neighborhood must be based on the nearby features. Given a physical limitation of what is called a neighborhood of a gate, the number of possible gate configurations is finite, and thus it is possible to classify each gate in a layout as belonging to one such category. One possible embodiment of the classification of gates involves labeling gates depending on their orientation in the layout (vertical, horizontal, 45 degrees, 135 degrees, etc.), spacing to the neighboring gates (nearest and possibly more distant neighbors), and the relative position of the surrounding gates (the neighbor to the west vs. east). Other categories may be added if justified by the complexity of the manufacturing process.

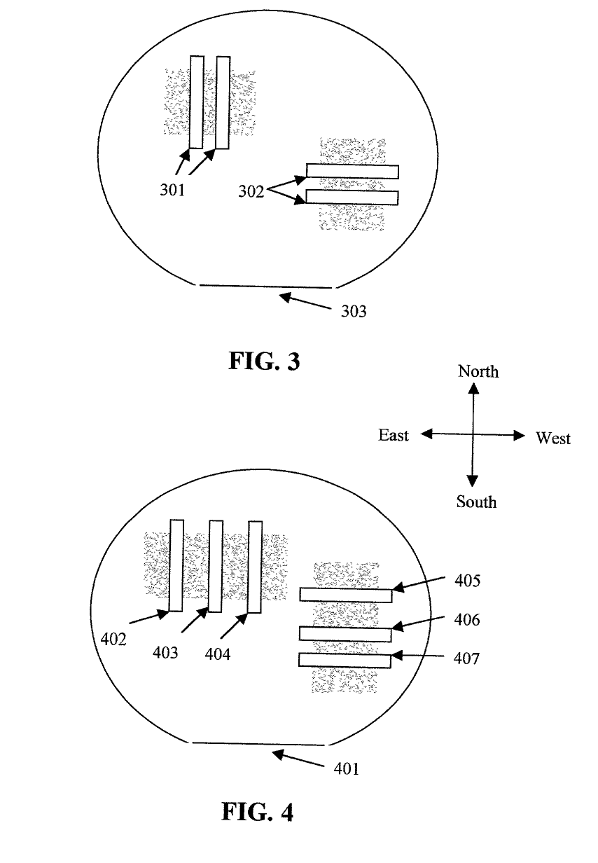

The orientation, vertical 301 vs. horizontal 302, is determined with respect to the flat of the wafer 303, as illustrated in FIG. 3. Other orientations could be involved, as would be apparent to one of ordinary skill in the art.

Referring to FIG. 4, one embodiment of the classification of gates includes attaching a label representing the orientation and a description of the neighborhood. This embodiment of the labeling method of the neighborhood involves specifying the distance to the closest neighbor on each side of the said gate. This embodiment further involves attaching three labels to each gate, the first representing the orientation (vertical (V), horizontal (H)), and two labels referring to the distance to neighbors on either side. The label for a vertical gate would be VXY, where X and Y correspond to the distance to the neighbors to the east and west, respectively. The label for a horizontal gate would be HXY, where X and Y correspond to the distance to the neighbors to the north and south, respectively. The directions, east, west, north, and south, as used herein, are defined with respect to the flat of the wafer 401, and are not intended to suggest any particular absolute orientation with respect to external objects. This embodiment of the labeling method assigns numbers corresponding to distances. In particular, “1” refers to the smallest distance, “2” refers to an intermediate distance, and “3” refers to a large distance. Gate 402 is labeled V32; gate 403 is labeled V22; gate 404 is labeled V23; gate 405 is labeled H32; gate 406 is labeled H21; and gate 407 is labeled H13. Other labeling methods and descriptions of the neighborhood may be used to practice the present invention, as would be apparent to one of ordinary skill in the art from the description herein.

To generate the CD maps, the following steps may be performed. The design rules for a process and/or a technology-mapped netlist (layout) are analyzed to determine all the possible gate configurations (neighborhoods). To increase efficiency, the layout, describing the circuit design, may be analyzed to determine the frequency of the various gate configurations (neighborhoods) in the circuit. This involves applying a technique for labeling all gates according to their neighborhood and orientation, as illustrated above, and counting the number of gates in each category. This is to determine which gate categories are the major ones. The major gate categories are to be measured, and if necessary, manufactured as test structures and measured. Selecting the most frequent gate configurations results in reduced measurement time, and saves silicon area and cost in the design and manufacturing of the test structures. This is because the total number of categories may be large, and measuring the CD for all of them is expensive. In general, however, the step involving selecting only the most frequent configurations for measurement and inclusion in a test structure may be skipped. Any method, known to those skilled in the art, may be used to select the gate configurations to be used in the test structure and/or to be measured.

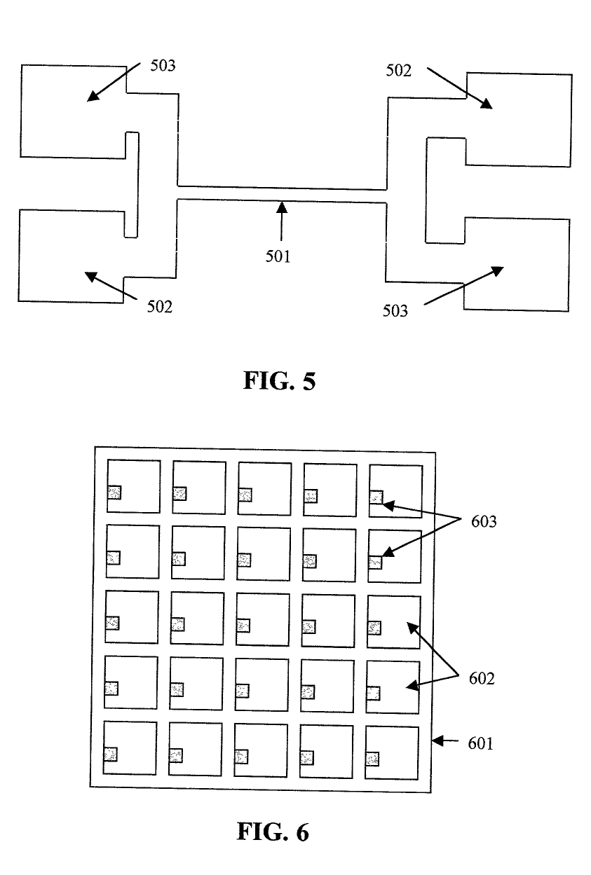

A test structure is designed for the gate categories found to be important. A test structure is an IC containing manufactured features for the purpose of better understanding the details of the IC manufacturing process. The present invention involves a test structure which includes copies of the transistors with their corresponding neighborhood or of resistors, created with the same or a similar set of manufacturing steps as the transistor gate, whose width is the gate CD. For example, if the transistor gate is composed of polysilicon, then the resistors are also composed of polysilicon. Slight variations in the manufacturing process of the resistors are possible to enhance accuracy in measurement, as would be clear to one of ordinary skill in the art. An example would be omission of the silicide layer for the resistors, normally included in transistor gates. Each of the resistors 501 may be attached to pads so that the resistance can be measured, as illustrated in FIG. 5. To measure the resistors, a current is applied through two of the pads 502, and voltage is measured across the other two 503. The measured voltage is then used to calculate the CD.

The test structure is created by replicating the transistors and/or resistors to form a grid, covering a large portion of the optical field 601, as illustrated in FIG. 6. The set of transistors and/or resistors included in the test structure are replicated with as high spatial frequency as possible. Hence, each instance of a transistor and/or resistor 603 is replicated many times, as specified by the grid 602. A finer spatial resolution will provide higher modeling accuracy for the spatial CD maps. When the test structure is measured, it is important to make a statistically significant number of replicated measurements for each location, in order to guarantee that the resulting CD map is statistically significant and is know with sufficient accuracy, as understood by those skilled in the art.

The present invention does not, however, depend on the use of measured data from the test structure to generate the topological CD maps for different gate categories, even though, this is the method of choice for the preferred embodiment of the present invention. Alternative ways to generate the CD maps include using a lithography and/or process simulator, using optical CD measurements on any manufactured wafer, or using any combination of the above methods.

Once the CD data is collected, CD(x,y) (the intra-field spatial CD map) can be extracted for each gate category (configuration) using various statistical techniques, as would be apparent to one of ordinary skill in the art, e.g., by taking the mean of the CD measurements at each spatial location within the field. More sophisticated approaches to decomposition and extraction are possible.

Once the set of CD maps is generated, they have to be converted to a set of gate length (L) maps for use in circuit analysis. The relation between CD and L is usually modeled as a linear shift, and the value of the shift is determined through the comparison of the measured and simulated current drive values. Any other convenient way of relating L to CD may be used as an alternative. The result is “L maps” for each gate category.

B. Circuit Analysis

To run accurate post-layout analysis circuit analysis both layout and netlist representations of the circuit are needed. If not available, the netlist can be extracted from the layout. The layout and the netlist are then passed to a tool that analyzes the neighborhood of each gate, classifies it as belonging to a particular category, and determines its spatial location within the layout (chip) and optical field. Using this information, together with the set of “L maps” produced at the stage of characterization described above, the tool then generates a modified netlist in which each gate has a proper location and neighborhood dependent L value. The modified netlist may then be input into any standard CAD tool to calculate performance metrics, like speed and power dissipation. Some examples of such CAD tools include SPICE, SPICE-like simulators, PathMill, PowerMill, etc.

Some circuits may be composed of standard cells and other larger blocks, and may be too large to practically implement the method described above. Instead, each block is pre-characterized and a model of its performance metrics is created. The CAD tools then operates on the models of the blocks to estimate the performance metrics for the entire circuit.

The most common embodiment of such a design is a design composed of standard cells. Note that most designs are combinations of standard cells and other circuit blocks. The embodiment of our methodology for standard cell designs is described herein in more detail for the sake of clarity.

For standard cell designs, the layout is hierarchical. Each geometrical instance in the layout belongs to one of the pre-defined and pre-characterized library cells. In this case, circuit analysis is performed at the cell level using CAD tools, such as PrimeTime or Pearl. If we consider the example of timing analysis, a static timing simulator calculates the delays of all the paths in the circuit by adding the delays associated with each gate in the circuit. The simulator assesses this delay by looking up the value for the delay of the in the corresponding cell library. Incorporating spatial and neighborhood dependence of the gate CD requires the incorporation of this information in the pre-characterization of the library cells.

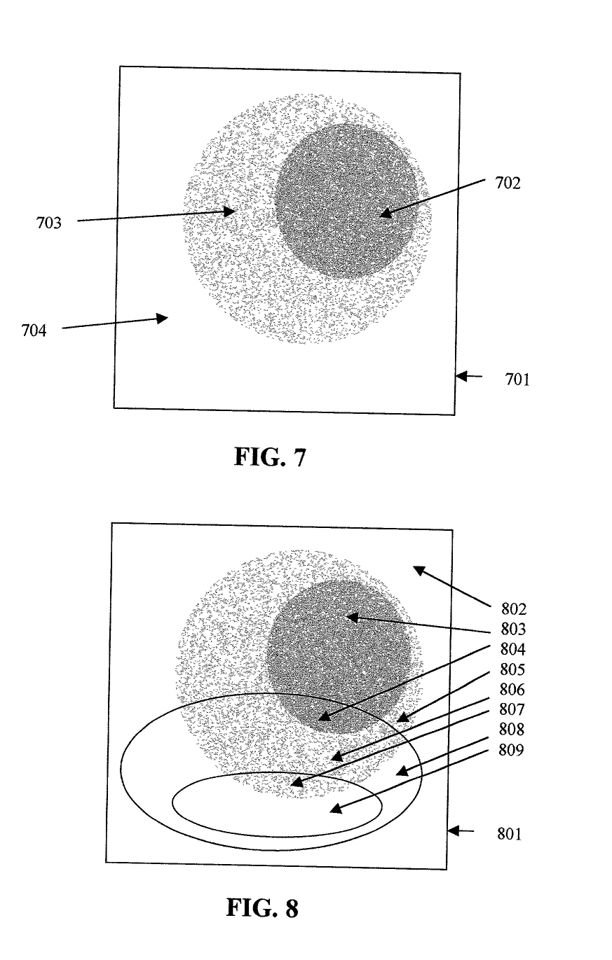

Two ways of incorporating spatial and neighborhood dependence of the CD in the pre-characterization of the library cells are possible. The first embodiment of the present invention involves generating multiple versions of the delay models (or models of other performance metrics) for each unique cell in the library: one delay model for each of the several possible CD (or L) values within the expected range of variation of CD (or L). Under this approach, for each gate category (with a specific orientation and set of neighboring features) the full range of variation is divided into bands, according to the desired modeling resolution, R. Each band is represented by a single value of CD and L. Each band then translates to a specific area in the optical field associated with a single value of CD and L. FIG. 7 illustrates the case where the CD for a gate is represented by three bands in the optical field 701, one band corresponding to a smallest value of the CD 702, a second band corresponding to the largest value of the CD 704, and a third band corresponding to an intermediate value of CD 703. A gate encountered in each of these regions is characterized with different representative values of CD and L. The selection of modeling resolution, R, which determines the number of discrete values of CD and L, introduces a tradeoff between computer memory, effort, and accuracy, since computer memory and effort increase in accordance with the modeling resolution.

Each cell in the library contains a combination of gates in different neighborhoods. This means that models for each cell must be based upon the layout of the said cell. The problem is complicated by the fact that the CD maps for different gate categories are different. As a result, when determining the models of a cell as a function of position within the optical field, the number of models required to cover the optical field is a function of all of the gate categories within the cell. FIG. 8 shows areas of the optical field 801 associated with bands of CD for two transistor categories. The areas of the optical field 802, 803, 804, 805, 806, 807, 808, and 809 all correspond to areas represented by different models of cell performance, because each of the two transistor categories have a different combination of CDs. A cell library would require models corresponding to each of the areas associated with each unique combination of CD values associated with each of the gate categories contained in each cell.

It should be noted that the neighborhood of a transistor in a specific cell in the cell library is a function of not just the other transistors and geometries within the cell, but also the transistors and other features in the neighboring cells. As a result, the model for a specific cell in the cell library may be a function of its final placement and neighbors in the final layout of the design. Consequently, modeling accuracy is improved if models are created for each of the cells in the cell library considering a multitude of neighboring geometries for each cell, which in turn translates to creating a larger number of models for each cell in the cell library, in order to cover both variation within the optical field and all possible configurations for neighbors for each cell.

The second embodiment of the present invention for incorporating the spatial and neighborhood dependence of the CD in the pre-characterization of the library cells involves calculating the delay or other performance metrics of the cell as a function of the gate length, L, of each of the transistor categories within the cell. Standard statistical modeling methods, as familiar to those skilled in the art, are utilized to determine the model. The resulting model is called a response surface model, and is specific for each individual cell in the cell library. During a run of the simulator, when a delay calculator, for example, prompts for the delay of a particular cell, the cell type, together with the spatial location of this cell is passed to the cell look-up agent. Before addressing the cell, the cell look-up agent extract the exact gate length, L, for each transistor category in the cell from the CD maps using the known spatial location of the gate. The agent addresses the cell and calculates the delay value for this cell using the response surface model based on the gate length for each transistor category in the cell. The agent passes the delay value to the delay calculator. Compared to the first embodiment of the method, this method is more accurate (because it allows for a continuous value of gate length, L, i.e. perfect resolution, R, and also requires less computer memory (because it does not generate multiple cell library files).

C. Technology-Dependent Floor Planning

The extracted CD maps may be used to perform floor planning, which is the placement of the circuit modules of the IC within the die. A cost function that includes a location-dependent performance metric is introduced, which leads to a more optimal placement of the blocks in the chip with respect to speed, power, yield, and/or any other circuit performance metric. For example, a block of critical circuitry will be placed in the chip area, where CD is minimal to achieve the highest speed, if the optimization is for speed. On the other hand, if the optimization is for power, the block consuming the most power will be placed in the chip area having the smallest leakage current (largest CD), and thus, achieve the smallest stand-by power. Similarly, yield is inversely related to CD, and circuit blocks that are most likely to have functional or parametric failures due to high leakage current in the transistors or any other failure mechanism may be placed in the regions with higher CD.

The invention is limited only as defined in the following claims and equivalents thereof.

We claim:

1. A device to measure gate critical dimension (CD) in different positions on a semiconductor wafer, said device comprising:
an oxide layer or similar insulating layer deposed on a silicon wafer;
a polysilicon layer, or a layer of any other material or set of steps and materials as used or similar to those used to manufacture transistor gates, henceforth referred to as the “gate” layer, deposed on the oxide or insulating layer, patterned to form resistors and other shapes; and
a grid, where each site contains copies of several resistors, each with surrounding shapes composed of the same materials as the resistors.

2. The device in claim 1, wherein said resistors and surrounding features correspond to gates that are likely to be found in an integrated circuit (IC) layout, as defined by the physical design rules; wherein each resistor has specific features, such as, but not limited to:
a specified orientation (for example, but not limited to vertical, horizontal, 45 degree orientations); and
a neighborhood of other features composed of the same material and created with the same fabrication steps (for example, but not limited to nearby features with a specified distance to the resistor, possibly differentiating between features to the north, south, east, and west of the resistor).

3. A method for labeling all gates in a specific integrated circuit (IC) layout, according to any or all of the features below:
A. classifying all gates in the said layout of a circuit depending on orientation (for example, but not limited to vertical, horizontal, 45 degrees orientations);
B. classifying all gates in a circuit design with a physical layout depending on their neighborhood, i.e. set of nearby features in the same layer of the layout (for example, but not limited to distance to nearest neighbors and more distant neighbors and/or a complete description of the neighborhood, as defined by a physical distance to other features); and
C. classifying all gates in a circuit design within a physical layout depending on the relative positions of neighboring structures in the same layer of the layout (for example, east vs. west neighbors, north vs. south neighbors, and/or a complete description of the neighborhood, as defined by physical distance and location of adjacent structures with respect to each said gate).

4. A method for determining the most frequent gate categories in a specific integrated circuit (IC) layout, said method including steps of:
A. labeling all gates according to the method of claim 3;
B. determining the number of gates in each category in step A; and
C. selecting the categories with the largest number of gates.

5. A device to measure gate critical dimension (CD) in different positions on the semiconductor wafer, said device comprising:
an oxide or similar insulating layer deposed on a silicon wafer;
a polysilicon layer, or a layer of any other material or set of steps and materials as used or similar to those used to manufacture transistor gates, referred to as the “gate” layer, deposed on the oxide or insulating layer, patterned to form resistors and other shapes, wherein said resistors and surrounding features are selected to correspond to the most frequent features in a specific integrated circuit (IC) layout, according to the method of claim 4; and
a grid, where each site contains copies of several resistors, each with surrounding shapes composed of the same materials as the resistors.

6. The device in claim 1, 2, or 5, said device further comprising a detector containing four pads, composed of polysilicon and/or other materials, as needed to connect to each resistor, two on each end, to be measured by attaching (a) a current generator for applying a current through each resistor and (b) a voltage meter for measuring the voltage across each of the resistors and wherein the measured voltage is used to calculate the resistance and width (CD) of each resistor.

7. A device to measure gate critical dimension (CD) in different positions on the semiconductor wafer, said device comprising:
transistors and other shapes, wherein said transistors and surrounding features correspond to gates that are likely to be found in an integrated circuit (IC) layout, as defined by the physical design rules; wherein each transistor has specific features, such as, but not limited to (a) a specified orientation (for example, but not limited to vertical, horizontal, 45 degree orientations) and (b) a neighborhood of other features composed of the same gate materials (for example, but not limited to nearby features with a specified distance to the transistor, possibly differentiating between features to the north, south, east, and west of the transistor); and
a grid, where each site contains copies of several transistors, each with surrounding shapes.

8. A device to measure gate critical dimension (CD) in different positions on the semiconductor wafer, said device comprising:
transistors and other shapes, wherein said transistors and surrounding features correspond to gates that are likely to be found in an integrated circuit (IC) layout, as defined by the physical design rules; wherein said transistors and surrounding features are selected to correspond to the most frequent features in a specific integrated circuit (IC) layout, according to the method of claim 4; and
a grid, where each site contains copies of several transistors, each with surrounding shapes.

9. A method for representing the gate critical dimension (CD) within an optical field on a semiconductor wafer, said method including the steps of:
A. fabricating a collection of semiconductor wafers including multiple copies of the device of claim 6, according to the lithographic and manufacturing procedures as used for printing the “gate” layer and other relevant steps of other integrated circuits;
B. measuring the device by (a) attaching a current generator for applying a current through each resistor and (b) attaching a voltage meter for measuring the voltage across each of the resistors, to find the CD for each resistor, where each resistor is labeled according to position within the optical field (x,y), category (cat), and instance (i), to produce a data set with values CD(x,y,cat,i); and
C. representing the gate critical dimension within a optical field as CD(x,y,cat) by averaging values for each instance.

10. A method for representing the gate critical dimension (CD) within a optical field on a semiconductor wafer, said method including the steps of:
A. fabricating a collection of semiconductor wafers including multiple copies of the device of claim 6, according to manufacturing procedures used for other integrated circuits, except varying the lithographic procedures for printing the “gate” layer (focus, exposure settings, for example) to include conditions representing manufacturing extremes according to an experimental design, as would be understood by those skilled in the art;
B. measuring the device by (a) attaching a current generator for applying a current through each resistor and (b) attaching a voltage meter for measuring the voltage across each of the resistors, to find the CD for each resistor, where each resistor is labeled according to position within the optical field (x,y), category (cat), and instance (i), to produce a dataset with values CD(x,y,cat,i); and
C. representing the gate critical dimension within the optical field as CD(x,y,cat) by averaging the values for each instance, or by applying a weighted averaging technique.

11. A method for representing the gate critical dimension (CD) within an optical field on a semiconductor wafer, said method including the steps of:
A. fabricating a collection of semiconductor wafers including multiple copies of the device of claim 1, 2, 5, 7, or 8, according to the lithographic and manufacturing procedures as used for printing the “gate” layer and other relevant steps of other integrated circuits, until completion of patterning of the “gate” layer;
B. measuring the CD of each instance of each gate or resistor with standard methods apparent to those of ordinary skill in the art (i.e. optical techniques) where each measurement is labeled according to the position within the optical field (x,y), category (cat), and instance (i), to produce a data set with values CD(x,y,cat,i); and
C. representing the gate critical dimension within the optical field by averaging the values for each instance.

12. A method for representing the gate critical dimension (CD) within an optical field on a semiconductor wafer, said method including the steps of:
A. fabricating a collection of semiconductor wafers including copies of the device of claim 1, 2, 5, 7, or 8, according to manufacturing procedures used for other integrated circuits, until completion of patterning of the “gate” layer, except varying the lithographic procedures for printing the “gate” layer (focus, exposure settings, for example) to include conditions representing manufacturing extremes according to an experimental design, as would be understood by those skilled in the art;
B. measuring the CD of each instance of each gate or resistor with standard methods apparent to those of ordinary skill in the art (i.e. optical techniques), where each measurement is labeled according to the position within the optical field (x,y), category (cat), and instance (i), to produce a data set with values CD(x,y,cat,i); and
C. representing the gate critical dimension within the optical field as CD(x,y,cat) by averaging the values for each instance, or by applying a weighted averaging procedure.

13. A method for representing the gate critical dimension (CD) within a optical field on a semiconductor wafer used for fabrication of an integrated circuit, said method including the steps of:
A. fabricating a collection of semiconductor wafers using the standard procedures used for producing multiple copies of an integrated circuit product, until completion of patterning of the “gate” layer;
B. partitioning the optical field into segments, labeled by position (x,y), and identifying representative gates corresponding to each category (cat);
C. measuring the CD of each instance of each representative gate with standard methods apparent to those of ordinary skill in the art (i.e. optical techniques), where each measurement is labeled according to position within the optical field (x,y), category (cat), and instance (i), to produce a dataset with values CD(x,y,cat,i); and
D. representing the gate critical dimension within the optical field as CD(x,y,cat) by averaging the values for each instance.

14. A method for representing the gate critical dimension (CD) within a optical field on a semiconductor wafer used for fabrication of an integrated circuit, said method including the steps of:
A. fabricating a collection of semiconductor wafers using the standard procedures used for producing multiple copies of an integrated circuit product, until completion of patterning of the “gate” layer, except varying the lithographic procedures for printing the “gate” layer (focus, exposure settings, for example) to include conditions representing manufacturing extremes according to an experimental design, as would be understood by those skilled in the art;
B. partitioning the optical field into segments, labeled by position (x,y), and identifying representative gates corresponding to each category (cat);
C. measuring the CD of each instance of each representative gate with standard methods apparent to those of ordinary skill in the art (i.e. optical techniques), where each measurement is labeled according to position within the optical field (x,y), category (cat), and instance (i), to produce a dataset with values CD(x,y,cat,i); and
D. representing the gate critical dimension within the optical field as CD(x,y,cat) by averaging the values for each instance, or by applying a weighted averaging procedure.

15. The method of claim 9, 10, 11, 12, 13, or 14, further including steps of:
A. calibrating (optimizing internal settings of) a lithography or process simulator to best approximate measured data, CD(x,y,cat); and
B. using the same settings to run the lithography or process simulator to obtain CD(x,y,cat) for categories not included in the original data set.

16. The method of claim 10, 12, or 14, further including steps of:
A. averaging the values of CD(x,y,cat,i) for each different setting of the lithographic equipment (focus, exposure, for example), to obtain CD(x,y,cat,setting);
B. calibrating a lithography or process simulator to best approximate measured data, CD(x,y,cat,setting);
C. using the same settings to run the lithography or process simulator to obtain CD(x,y,cat,setting) for categories not included in the original data set; and
D. calculating CD(x,y,cat) for categories not included in the original data set by averaging CD(x,y,cat,setting), or by using a weighted averaging procedure.

17. A method for estimating circuit properties (power, speed, yield, etc.), said method including the steps of:
A. labeling all gates of a layout of the circuit by classifying gates by any or all of the following criteria to specify their category (cat): (i) orientation, (ii) neighborhood features within the same layer of the layout (for example, but not limited to the distance to nearest neighbors and/or more distant neighbors), and (iii) relative positions of neighboring structures within the same layer of the layout (for example, but not limited to east vs. west neighbors, north vs. south neighbors) and labeling all gates according to location in the optical field (x,y);
B. labeling the corresponding gates in the netlist according to category (cat) and location in the optical field (x,y);
C. finding the relation between gate length, L, in the netlist, and CD, as would be easily determined by one skilled in the art;
D. modifying the netlist by modifying L(x,y,cat) for each gate based on CD data, CD(x,y,cat), given any choice of CD(x,y,cat), determined by a method apparent to one of ordinary skill in the art or by any of the methods of claims 9, 10, 11, 12, 13, 14, 15, and 16, and where missing values of CD(x,y,cat) are determined via an interpolation procedure; and
E. inputting the modified netlist to standard software tools to estimate circuit properties (power, speed, yield, etc.).

18. A method for estimating properties (power, speed, yield, etc.) of each cell in a cell library and for creating a corresponding model of each cell, as a function of position (x,y) in the optical field, said method including the steps of:
A. determining CD(x,y,cat) by a method apparent to one of ordinary skill in the art or by any of the methods of claims 9, 10, 11, 12, 13, 14, 15, and 16;
B. determining the maximum and minimum values of CD(x,y,cat), for all values of x and y and all categories, and partitioning the range from the minimum to maximum values into segments;
C. determining the corresponding sets of values, x and y, corresponding to each segment for each category;
D. finding each set of values of x and y, with CD(x,y,cat) falling in the same segment for all categories, S(x,y);
E. labeling all gates of a layout of the cell in the cell library by any or all of the following criteria to specify their category (cat): (i) orientation, (ii) neighborhood features within the same layer of the layout (for example, but not limited to the distance to nearest neighbors and/or more distant neighbors), and (iii) relative positions of neighboring structures within the same layer of the layout (for example, but not limited to east vs. west neighbors, north vs. south neighbors) and labeling the corresponding gates in the netlist according to category (cat), while assuming neighboring cells which have assumed features at an assumed distance;
F. finding the relation between gate length, L, in the netlist, and CD, as would be easily determined by one skilled in the art;
G. modifying the netlist corresponding to a cell in location S(x,y) by modifying L(cat) for each gate based on CD data, CD(x,y,cat), where missing values of CD(x,y,cat) are determined via an interpolation procedure; and
H. inputting the modified netlist to standard software tools to estimate properties of each cell in the cell library (power, speed, yield, etc.) and to create the model of each cell in location S(x,y) with the assumed neighboring features.

19. A method for estimating properties (power, speed, yield, etc.) of each cell in a cell library and for creating a corresponding model of each cell, as a function of position (x,y) in the optical field, said method including the steps of:
A. labeling all gates of a layout of the cell in the cell library using the method of claim 3 and labeling the corresponding gates in the netlist according to category (cat), while assuming neighboring cells which have assumed features at an assumed distance;
B. varying L for each gate category according to an experimental design, as practiced by one of ordinary skill in the art, and inputting the modified netlist to standard software tools for each value of L to estimate properties of each cell in the cell library (power, speed, yield, etc.); and
C. generating a function (model) which represents the properties of each cell in the cell library (power, speed, yield, etc.) as a function of L for each category, using modeling methods known to those skilled in the art.

20. A method for estimating circuit properties (power, speed, yield, etc.), said method including the steps of:
A. creating models of all cells in a standard cell library as a function of position (x,y) in the optical field using the method of claim 18;
B. labeling all instances of standard cells in a circuit according to position (x,y) in the optical field; and
C. inputting the location-dependent models to standard software tools to estimate circuit properties (power, speed, yield, etc.).

21. A method for estimating circuit properties (power, speed, yield, etc.), said method including the steps of:
A. labeling all gates of a layout of each of the cells in the cell library by any or all of the following criteria to specify their category (cat): (i) orientation, (ii) neighborhood features within the same layer of the layout (for example, but not limited to the distance to nearest neighbors and/or more distant neighbors), and (iii) relative positions of neighboring structures within the same layer of the layout (for example, but not limited to east vs. west neighbors, north vs. south neighbors) and labeling the corresponding gates in the netlist according to category (cat), while assuming neighboring cells which have assumed features at an assumed distance;
B. creating models of all cells in the standard cell library as a function of gate length by varying L for each gate category according to an experimental design, as practiced by one of ordinary skill in the art, inputting the modified netlist to standard software tools to estimate properties of each cell in the cell library (power speed, yield, etc.) for each value of L, generating a function with represents the properties of each cell as a function of L for each gate category, using modeling methods known to those skilled in the art;
C. labeling all instances of standard cells in a circuit according to position (x,y) in the optical field;
D. determining L(x,y,cat) by creating CD(x,y,cat) by any method apparent to one of ordinary skill in the art or by any of the methods of claims 9, 10, 11, 12, 13, 14, 15, and 16, and by finding the relation between gate length, L, in the netlist, and CD, as would be easily determined by one skilled in the art; and
E. inputting the models from step A into standard software tools to estimate circuit properties (power, speed, yield, etc.), which lookup corresponding values of L(x,y,cat) during model evaluation.

22. A method for creating the layout of an integrated circuit (IC) chip, said method including the steps of:
A. creating models of properties (area, speed, power, yield, etc.) for each of the blocks of a circuit as a function of position using one of the methods in claims 17, 18, 20, and 21; and
B. inputting the models into a floor planning or other layout generation tool for use in the cost function, which guides layout generation.

23. A method for increasing the speed of an integrated circuit (IC) chip by modifying the layout, said method including the steps of:
A. creating models of speed for each of the cells and blocks of a circuit as a function of position using one of the methods in claims 17, 18, 20, and 21;
B. inputting the models to standard software tools to determine the critical paths of the circuit; and
C. laying out the circuit so that cells and blocks most strongly influencing the speed of the circuit are placed in locations with smaller CD, where speed is measured by inputting the models of each of the cells into a standard CAD tool for timing estimation.

24. A method for reducing the power dissipation of an integrated circuit (IC) chip by modifying the layout, said method including the steps of:
A. creating models of power dissipation for each of the cells and blocks of a circuit as a function of position using one of the methods in claims 17, 18, 20, and 21;
B. inputting the models to standard software tools to determine the power dissipation of the circuit; and
C. laying out the circuit so that cells and blocks most strongly influencing the power dissipation of the circuit are placed in locations with larger CD, where power dissipation is measured by inputting the models of each of the cells into a standard CAD tool for power estimation.

25. A method for increasing the yield of an integrated circuit (IC) chip by modifying the layout, said method including the steps of:
A. creating models of yield for each of the cells and blocks of a circuit as a function of position using one of the methods in claims 17, 18, 20, and 21; and
B. laying out the circuit so that cells and blocks with lowest yield are placed in locations with larger CD.
